(19) United States
(12) Patent Application Publication
(10) Pub. No.: US 2008/0254850 A1
(43) Pub. Date: Oct. 16, 2008

(54) Trusted Computing in a Wagering Game Machine

(75) Inventor: Craig J. Sylla, Round Lake, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 11/913,701

(22) PCT Filed: May 8, 2006
(86) PCT No.: PCT/US2006/017545

§ 371 Date: Nov. 6, 2007

Related U.S. Application Data
(60) Provisional application No. 60/678,367, filed on May 6, 2005.

(51) Int. Cl. A63F 9/24; G06F 17/00

(52) U.S. Cl. 463/16; 463/25; 463/43

(57) ABSTRACT

A computerized wagering game system has a gaming module and trusted platform module. The gaming module comprises a processor and gaming code which is operable when executed on the processor to conduct a wagering game on which monetary value can be wagered; and the trusted platform module is operable to authenticate information on the wagering game machine such as by authenticating the hardware configuration, authenticating the software configuration, or securing communication between the computerized wagering game system and another computerized system.

### RELATED APPLICATION

This application claims the priority benefit of U.S. Provisional Application Ser. No. 60/678,367 filed May 6, 2005, the contents of which are incorporated herein by reference.

### FIELD OF THE INVENTION

The invention relates generally to computerized wagering game machines, and more specifically to trusted computing in wagering game machines.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Traditional mechanical wagering game machines such as slot machines have largely been replaced by computerized electronic wagering game systems, which are also rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they should be fair, they should provide sufficient feedback to the game player to make the game fun to play, and they should meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the wagering game's hardware and software to conduct and present the wagering game to the player. Because the wagering game must meet a variety of regulatory requirements and provide a fair and predictable gaming experience to the player, it is important that the wagering game's hardware and software remain authentic and unaltered.

Examples of problems with a gaming machine's authenticity include such things as a hardware malfunction or alteration, or an alteration in software such that the game has changed. There is strong motivation for dishonest players to try to alter the wagering game system to provide odds in the game player's favor or to cheat the wagering game system, such as by replacing or altering software within the wagering game machine.

It is therefore desirable to provide a wagering game machine environment in which the authenticity of the wagering game system can be verified.

### SUMMARY

One example embodiment of the invention comprises a computerized wagering game system having a gaming module and trusted platform module. The gaming module comprises a processor and gaming code which is operable when executed on the processor to conduct a wagering game on which monetary value can be wagered; and the trusted platform module is operable to authenticate information on the wagering game machine such as by authenticating the hardware configuration, authenticating the software configuration, or securing communication between the computerized wagering game system and another computerized system.

### BRIEF DESCRIPTION OF THE FIGURES FIG. 1 shows a computerized wagering game machine, as may be used to practice some example embodiments of the present invention.

FIG. 2 is a block diagram of a computerized wagering game system employing a trusted platform module, consistent with an example embodiment of the invention.

FIG. 3 is a block diagram of a trusted platform module, as is incorporated into computerized wagering game machines in some example embodiments of the invention.

FIG. 4 is a flowchart of a method of operating a computerized wagering game system having a trusted platform module, consistent with an example embodiment of the present invention.

FIG. 5 is a block diagram of a network of computerized wagering game devices, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Various examples of the present invention presented here seek to provide a secure computing environment for computerized wagering game systems by using a trusted platform module or equivalent technology. One example embodiment of the invention comprises a computerized wagering game system having a gaming module and trusted platform module. The gaming module comprises a processor and gaming code which is operable when executed on the processor to conduct a wagering game on which monetary value can be wagered; and the trusted platform module is operable to authenticate information on the wagering game machine such as by authenticating the hardware configuration, authenticating the software configuration, or securing communication between the computerized wagering game system and another computerized system.

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. Alternate embodiments of the invention will have other game indicators, such as mechanical reels instead of the video graphics reels shown at 102 that comprise a part of a video slot machine wagering game.

A game of chance is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, including such well-known wagering games as reel slots, video poker, blackjack, craps, roulette, or hold 'em games. The wagering game is played and controlled with inputs such as various buttons 103 or via a touchscreen overlay to video screen 101. In some alternate examples, other devices such as pull arm 104 used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 105 or a secure user identification module interface 106, and winnings are returned via the returned value card or through the coin tray 107. Sound is also provided through speakers 108, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

The wagering game system in some embodiments uses a trusted platform module (TPM), which is a hardware security device designed to perform one or more security functions such as encryption of data, authentication of data or of a machine's hardware or software configuration, secure storage of encryption or authentication keys, and other such functions. Trusted platform modules include hardware elements having equivalent functions, such as the Next Generation Secure Computing Base, or NSGCB, and other such hardware devices. These devices are desirable over performing equivalent functions in software because they can store and process data in a manner that doesn't expose secure information to other software, and because observation of data or tampering with data stored in a trusted platform module is much more difficult given that the data is stored in a protected form in hardware.

A variety of wagering games and wagering game systems can benefit from incorporation of trusted platform modules, including traditional standalone wagering game systems, such as in using the trusted platform module to authenticate the software and hardware components installed in the system. Wagering game systems coupled to a server or other wagering game machine such as in a progressive slot network can also use the trusted platform module to authenticate the identity of other coupled wagering game system devices, and to secure communication between wagering game devices in a network. Several examples of such wagering game systems are presented here as examples.

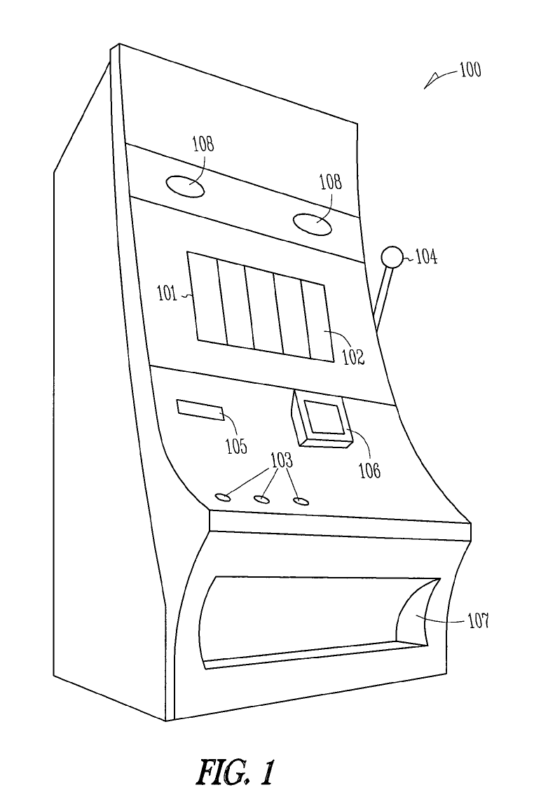

FIG. 2 shows a block diagram of a wagering game system employing a trusted platform module. A processor 201 is coupled to a bus 202 and a memory 203. Nonvolatile storage such as hard disk drive 204 or nonvolatile memory is coupled to the bus and is operable to store data when the wagering game machine is not in operation, such as when unplugged or powered off. A touchscreen display 205 is operable to present video and graphic data to a wagering game user, and to receive input via actuation of the touchscreen. One or more speakers 206 are operable to provide sounds such as music, sound effects, or spoken audio to the wagering game player, and one or more user interface device such as button 207, coin or credit input and pay devices, slot machine pullarms, and other such peripherals are coupled to the system's bus. The device may be connected to one or more other devices such as another wagering game machine, a progressive slot area controller, or a computer server via network connection 208.

A trusted platform module, or TPM, is shown at 209 and is operable to perform at least one of a variety of various authentication functions such as encryption, hardware configuration authentication, software configuration authentication, and key management. The trusted platform module in some embodiments will employ one or more encryption functions, such as a public key, private key, or hash function algorithm for use in authentication functions such as encryption, has function, and digital signature operations.

A symmetric algorithm relies on agreement of a secret key before encryption, and the decryption key is either the same as or can be derived from the encryption key. Secrecy of the key or keys is vital to ensuring secrecy of the data in such systems, and the key must be securely distributed to the receivers before decryption. Common symmetric algorithms include DES, 3DES or triple-DES, IDEA, and RC4. Implementation of symmetric key algorithms via a trusted platform module is desirable, as the secret key can be kept within the trusted platform module hardware in a form that is not directly readable.

Public key algorithms, or asymmetric algorithms, are designed so that the decryption key is different than and not easily derivable from the encryption key. The term “public key” is used because the encryption key can be made public without compromising the security of data encrypted with the encryption key. Anyone can therefore use the public key to encrypt a message, but only a receiver with the corresponding decryption key can decrypt the encoded data. The encryption key is often called the public key, and the decryption key is often called the private key in such systems. Common public key algorithms include RSA and Diffie-Hellman. Public key algorithms are typically used to encrypt data so that it can only be recovered with the private key. The owner of the key pair can encrypt data with his public key, knowing that it will be secured until it is decrypted with the secret private key. Similarly, a remote user or system can securely send encrypted data to the owner of the key pair by first encrypting the data with the public key, ensuring that only the owner of the private key is able to decrypt and view the data.

Public key algorithms can also be used for functions such as authentication of data, because a data file encrypted with a private key can only be decrypted using the corresponding public key. A document signed with a private key can be authenticated if a public key known to be associated with the signing private key can successfully decrypt the encrypted data, ensuring that it was signed with the correct private key. Secrecy of the private key is important for both signature and encryption applications, as one who has knowledge of the private key can digitally sign data and can decrypt data others have encrypted using the public key.

One-way hash functions take an input string and derive a fixed length hash value. The functions are designed so that it is extremely difficult to produce an input string that produces a certain hash value, resulting in a function that is considered one-way. Data can therefore be checked for authenticity by verifying that the hash value resulting from a given one-way hash function is what is expected, making authentication of data relatively certain. Hash functions can be combined with other methods of encryption or addition of secret strings of text in the input string to ensure that only the intended parties can encrypt or verify data using the one-way hash functions. Common examples of one-way hash function encryption include MD4, MD5, and SHA.

Any of the encryption methods described here and any other suitable encryption or authentication method can be implemented in various wagering game system embodiments, such as that of FIG. 2. In operation, the wagering game system loads program data from nonvolatile storage such as hard disk drive 204 or nonvolatile memory into the main system memory 203, and the processor 201 executes the program instructions. The trusted platform module is operable in various embodiments of the invention to encrypt or authenticate the software instructions, and to segregate or protect executing processes so that their data cannot be read or altered by other processes or programs executing on the computer system. This allows verification that the software instructions have not been changed since they were first authenticated, and protects the program instructions and other data from alteration when the software is loaded into memory and is executed in the processor.

The trusted platform module is operable to provide a variety of other functions, such as in environments where more than one wagering game machine is present in a wagering game system. In such examples, the trusted platform module can authenticate the identity of one machine to other machines connected via a network, and can attest to the integrity or authenticity of the software and hardware within the wagering game device. The encryption functions of the trusted platform module can also be used to establish secure encrypted communication between devices in a wagering game system, such as between a progressive slot controller and the progressive slot machines in the progressive slot network.

The hardware component of the trusted platform module, often embodied in a single integrated circuit operable to destroy or render unreadable the information contained therein when tampered with, works along with supporting software and firmware to provide the root of trust for the wagering game system device into which it is incorporated. Trust, or authentication, can be extended to other parts of the device or system by building a chain of trust back to the root, where each link in the chain of trust extends its trust to the next link. The trust can therefore be extended in various embodiments of the invention to devices, software, and other components of the wagering game system based on the root of trust established by the trusted platform module.

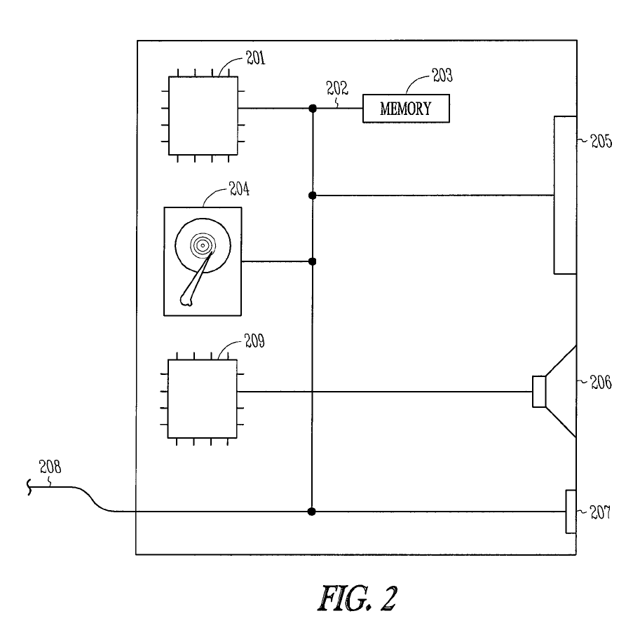

The trusted platform module integrated circuit in one example embodiment is an integrated circuit as shown in FIG. 3 that has the functions of a microcontroller 301 with cryptographic functions built in. The cryptographic functions allow certain operations to be conducted entirely within the trusted platform module integrated circuit, so that the operations are not monitorable via the pins of the integrated circuit or by other tampering methods. Hardware and software outside the trusted platform module do not have access to control or monitor the execution of these cryptographic functions or to the intermediate results, but can only provide input and receive output. This ensures the confidentiality of elements such as root keys within the trusted platform module integrated circuit.

A typical trusted platform module integrated circuit as shown in FIG. 3 has the hardware capability to perform up to 2048-bit RSA encryption and decryption, and can use the built-in RSA engine for digital signing and key signing operations in addition to encryption and decryption of data. It also incorporates a SHA-1 hash algorithm built into the hardware, operable to compute a hash of moderate-sized pieces of data. Larger data elements, such as an entire wagering game program or a volume such as a hard disk or nonvolatile memory used to store wagering game programs are typically hashed outside the trusted platform module due to its limited capacity and the limited amount of processing power in typical trusted platform module hardware. A random number generator 302 is also typically incorporated in the hardware of the trusted platform module, and is used to generate random numbers for things like key generation.

A typical trusted platform module uses a variety of keys, including root keys 303, endorsement keys 304, and attestation keys 305. The endorsement key, often simply referred to as EK, consists of a public key/private key pair that is typically of a 2048 bit size. The private component is generated within the trusted platform module hardware using its random number generator, and is never exposed outside the trusted platform module to preserve its secrecy. In an alternate embodiment, the endorsement key pair is generated during manufacture of the trusted platform module, and is embedded in the trusted platform module hardware during the manufacturing process.

The endorsement key 304 is unique to the particular trusted platform module and to the particular wagering game system or other system into which it is incorporated. The unique and secret nature of the private key can be used to guaranteed the trusted platform module's identity, and serves as the source of much of the trust or authenticity provided through the trusted platform module.

An attestation identity key 305, commonly called simply an AIK, is used to provide platform authentication to various other entities. The method used to sign or attest is sometimes known as direct anonymous attestation, or pseudoanonymous attestation, because although the attestation can be received and understood the attestor is not directly revealed by the attestation. For example, a wagering game device may attest to its identity, and in some further embodiments to its hardware or software configuration, upon first inclusion in a wagering game network such as a progressive slot pool. The progressive slot controller receives the attestation, but has no real knowledge of the identity of the attestor. The wagering game machine can then be removed, disconnected, or powered down, and upon its return can again attest to its identity or state. The progressive slot controller is able to confirm that the attestor is the same as the previous attestor, but still has no further knowledge of its true identity.

The trusted platform module architecture further includes a number of certificates, including an endorsement certificate 306, a platform certificate 307, and other certificates such a conformance certificate. The endorsement certificate contains the public key portion of the endorsement key, and can be used to confirm that a received message has been signed or encrypted with the private key portion of the endorsement key. The endorsement certificate can therefore be used to provide attestation that the trusted platform module is genuine, and that the endorsement key is protected and is a reliable root for authentication.

The platform certificate 307 is provided by the platform vendor, and is used to provide attestation that the particular trusted platform module is genuine, ensuring that the endorsement key is protected. Similarly, the conformance key is provided by the platform vendor or an evaluation lab to attest, via a signature from an accredited party or authority, that the security properties of the platform and of the trusted platform module are adequate.

The trusted platform module is accompanied by an entry in the BIOS of the wagering game system, ensuring that the trusted platform module is defined as a motherboard device within the ACPI descriptor tables. The operating system is thereby able to identify the trusted platform module, allocate resources to its operation, and to load necessary device drivers.

In some embodiments, the trusted platform module is also operable to store limited amounts of user data, such as file encryption keys, virtual private network keys, authentication keys, or other such data. Alternatively, the data can be stored in visible storage, but protected through the trusted platform module by encrypting the secret data such that it can only be decrypted by the trusted platform module containing the necessary private key. The trusted platform module implements a key hierarchy of all keys used for protected storage, based on a storage root key or SRK. Each key in the hierarchy is encrypted using the key that is at the next level up in the hierarchy.

Critical data can therefore be bound to a particular platform, such as a wagering game application bound to a particular wagering game machine or a progressive slot controller program tied to a particular progressive slot controller device. Data bound to a platform is only accessible to the bound platform if certain conditions specified in the binding are met, such as a hardware or software configuration of the platform. Information related to the platform configuration is calculated by the trusted platform module and stored in platform configuration registers within the trusted platform module. The trusted platform module merges data to be bound with the contents of the platform configuration registers and encrypts the combined data, so that the platform configuration register contents can be compared with the encrypted platform register contents upon attempting to recover the bound data.

Attestation identity keys are created in some embodiments using certificates within the trusted platform module, and are bound to the platform. They can therefore be used to provide attestation to the platform's identity and configuration. The service provider or challenger typically must therefore trust a trusted third party or certificate authority to issue attestation identity keys to platforms that are authentic and secure.

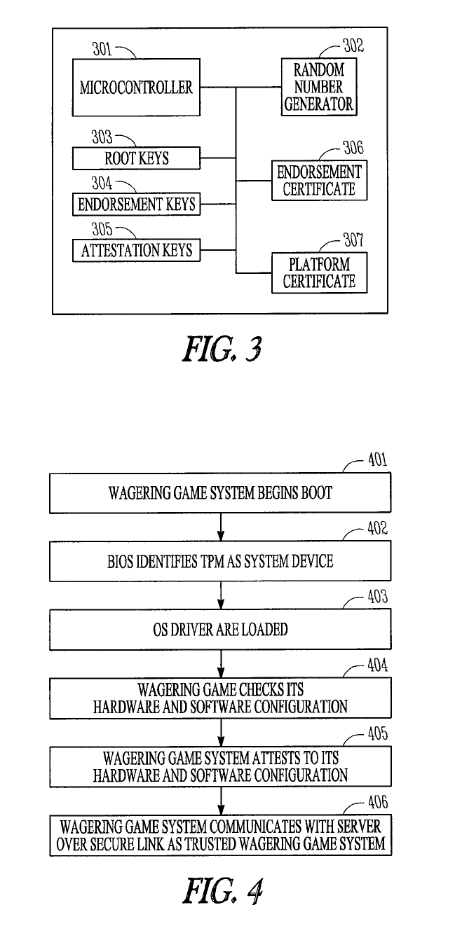

FIG. 4 is a flowchart, illustrating one method of employing a trusted platform module in a wagering game system. The wagering game boots at 401, and the BIOS identifies the trusted platform module as a motherboard device via its ACPI descriptor table entry at 402. The operating system then loads the drivers for the trusted platform module at 403, enabling software executing on the wagering game system to make use of the trusted platform module. Upon boot, the wagering game system checks its software and hardware configuration at 404 and compares its configuration to the data stored in the trusted platform module's platform configuration registers. The wagering game then attests to its hardware and software configuration to a wagering game server at 405, such as a server or progressive slot area controller. Once the identity of the wagering game machine and its configuration are attested to, the server can communicate with the wagering game knowing that the wagering game system is both a recognized machine and has not been tampered with or altered.

In alternate or further embodiments, the server or game controller has a trusted platform module therein, and the wagering game devices that exchange data with systems such as a progressive slot machine controller authenticate themselves to the wagering game machines, so that the wagering game machines know the data they receive from the controller or server is authentic.

The wagering game system establishes a secure communications link with the server or other wagering game system at 406, after authentication via the trusted platform module. The secure link is in one embodiment an IPSec link over a TCP/IP network, while in other embodiments comprises data encrypted with a session key, the public key of the intended receiving system, or via another function of the trusted platform module. Communication between the wagering game device and other wagering game system elements such as a server or progressive slot controller comprises in various embodiments reporting of wagering game state or results, receiving results or data for a wagering game presented on the wagering game system, or receiving updated software that is authenticated for installation.

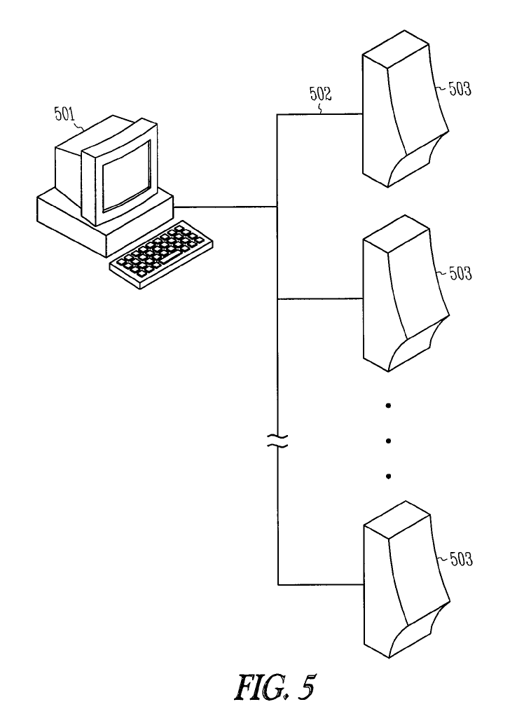

FIG. 5 is a system diagram illustrating a network of computerized wagering game systems employing trusted platform modules, consistent with an example embodiment of the present invention. A server 501 such as an accounting server, progressive slot area controller, or other wagering game device, is coupled via a network 502 to one or more computerized wagering game machines 503. The network is in some embodiments a wired network, while in other embodiments is a wireless network or other means of communication between the wagering game machines 503 and the server 501.

A wagering game upon which monetary value can be wagered is presented on the wagering game machines 503, and is conducted within the wagering game machines 503 or another device such as the server 501. In one example, the wagering game devices 503 are devices such as dedicated wagering game devices, cellular telephones, or other computerized devices having trusted platform modules operable to authenticate their state to the server, and in alternate or further embodiments the server 501 is operable to authenticate itself to the wagering game devices 503. The authentication function enables devices to leave and rejoin a network, while trusting that the other devices on the network are authentic.

This trust enables the wagering game devices 503 to know that they are coupled to an authentic wagering game server 501, and in some further embodiments to trust the wagering game results communicated from the server 501 to the wagering game presentation devices 503. In some example embodiments, the wagering game may be conducted or the results calculated in one machine and the results played in another, where at least one of the two wagering game devices authenticates its identity to the other via the trusted platform module. In further embodiments, communication between such wagering game system devices is encrypted using the trusted platform module of at least one machine. Encryption functions such as digital signatures and attestation are also used in some embodiments to send new program code from a server 501 to wagering game machines 503, or for other purposes such as accounting, configuration, or other functions that are desirably secure.

The examples presented here show a variety of ways in which a wagering game system can employ a trusted platform module to facilitate a variety of authentication, encryption, key management, digital signature, and other such functions Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1.-18. (canceled)

19. A wagering game system, comprising:
a trusted platform module operable to provide authentication;
a communication interface operable to exchange data with a wagering game server device operable to conduct a wagering game upon which monetary value can be wagered; and
a user interface operable to present the computerized wagering game upon which monetary value can be wagered to a user.

20. The wagering game system of claim 19, wherein the authentication provided via the trusted platform module comprises authentication of at least one of the hardware configuration and software configuration of the wagering game system.

21. (canceled)

22. The wagering game system of claim 19, wherein the trusted platform module is further operable to secure communication between the wagering game system and the wagering game server device.

23.-40. (canceled)

41. A method of operating a wagering game device, comprising:
providing authentication via a trusted platform module;
exchanging data with a wagering game server device operable to conduct a wagering game upon which monetary value can be wagered; and
presenting the computerized wagering game upon which monetary value can be wagered to a user.

42. The method of claim 41, wherein providing authentication via the trusted platform module comprises authentication of at least one of the hardware configuration and software configuration of the wagering game system.

43. (canceled)

44. The method of claim 41, further comprising securing communication between the wagering game system and the wagering game server device via the trusted platform module.

45. A computerized wagering game system, comprising:
a gaming module comprising a processor and gaming code which is operable when executed on the processor to present a wagering game on which monetary value can be wagered; and
at least one trusted platform module operable to authenticate data within the computerized wagering game system.

46. The computerized wagering game system of claim 45, wherein authentication of data within the computerized wagering game system comprises encryption or decryption of data.

47. The computerized wagering game system of claim 45, wherein authentication of data within the computerized wagering game system comprises computing a hash value.

48. The computerized wagering game system of claim 45, wherein authentication of data within the computerized wagering game system comprises computation of a digital signature.

49. The computerized wagering game system of claim 45, wherein authentication of data within the computerized wagering game system comprises attesting to a state of the computerized wagering game system.

50.-51. (canceled)

52. The computerized wagering game system of claim 45, wherein the at least one trusted platform module is further operable to protect stored data such that only an originating process can use the data.

53. The computerized wagering game system of claim 45, wherein the trusted platform module is further operable to isolate a first process such that other processes are not able to read or alter memory used by the first process.

54. A method of operating a computerized wagering game system, comprising:
presenting a wagering game on which monetary value can be wagered; and
authenticating data within the computerized wagering game system via a trusted platform module within the computerized wagering game system.

55. The method of operating a computerized wagering game system of claim 54, wherein authenticating data within the computerized wagering game system comprises encryption or decryption of data.

56. The method of operating a computerized wagering game system of claim 54, wherein authenticating data within the computerized wagering game system comprises computing a hash value.

57. The method of operating a computerized wagering game system of claim 54, wherein authenticating data within the computerized wagering game system comprises computation of a digital signature.

58-59. (canceled)

60. The method of operating a computerized wagering game system of claim 54, further comprising storing secure data within the trusted platform module such that the secure data is destroyed upon an attempt to physically observe the data.

61. The method of operating a computerized wagering game system of claim 54, further comprising protecting stored data via the trusted platform module such that only an originating process can use the data.

62. The method of operating a computerized wagering game system of claim 54, further comprising isolating a first process via the trusted platform module such that other processes are not able to read or alter memory used by the first process.

63.-72. (canceled)
